(19) United States
(12) Patent Application Publication
(10) Pub. No.: US 2005/0220670 A1
(43) Pub. Date: Oct. 6, 2005

(54) Multipath access system for use in an automated immunoassay analyzer

(76) Inventors: Thomas Palmieri, Paramus, NJ (US); Arthur L. Babson, Chester, NJ (US); Ilya Malyarov, Livingston, NJ (US); David Stein, Succasunna, NJ (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/813,604

(22) Filed: Mar. 31, 2004

(51) Int. Cl. G01N 35/00

(52) U.S. Cl. 422/64

(57) ABSTRACT

A multipath incubator that enables an immunoassay analyzer to perform tests that are not conducted serially relative to when the test samples entered the analyzer is provided.

### BACKGROUND OF THE INVENTION

1. Field of the Invention

The present invention generally relates to a multipath access system for use in an automated immunoassay analyzer. In particular, the invention provides a multipath access system that accepts a test vessel and acts as the conveyor while a sample and reagent are added to the test vessel and while the test vessel is incubated, agitated and washed. Then the multipath access system delivers the test vessel to a luminometer subsystem to be read.

### BACKGROUND DESCRIPTION

Automated immunoassay analyzers are being manufactured that allow a computer controlled system to analyze the amount of analyte in a sample such as blood, plasma or urine. To quantify the results, the sample is subjected to a myriad of complex processes that may include diluting of samples, adding reagents, incubating, agitating, washing and reading of the sample.

Automated immunoassay analyzers have traditionally performed the testing of samples in a serial manner. That is, a sample is presented to the analyzer and it progresses step by step through the various processes until completion. While this first sample is progressing through the analyzer, all other samples follow in order. There is a single path through currently available automated immunoassay analyzers and test vessels are processed on a first come first served basis. As such, the throughput of the analyzer is only as fast as the longest test cycle.

The types of chemical processes that are carried out in an automated analyzers typically involve multiple, discrete steps which must be separated from one another both physically and in time. In other words, reactive entities must be exposed to one another in a defined order, some components of a reaction may need to be removed prior to addition of other reagents, and the time of exposure of reactants to one another may vary. The ordering and timing of these processes varies widely depending on the nature of the chemical reactions being undertaken. The prior art has failed to provide automated analyzers with sufficient flexibility to allow for the efficient, simultaneous incubation of multiple samples with such differing incubation requirements.

### SUMMARY OF THE INVENTION

According to the invention, a multipath access system is provided. The multipath access system allows immunoassay tests to be performed in a controlled multiple path manner rather than in a first in first out (FIFO) serial process. The multipath access system may include a means for accepting or adding test vessels onto one of one or more continuous loop transport devices (belts). The multipath access system may also include at least one pipetting station where biological samples (e.g., plasma, blood, urine, etc.) are added to test vessels. The biological samples may be diluted or not, as specified by the particular assay. The one or more pipetting stations may also add reagents to the test vessels. The test vessels can be incubated and agitated as they are transported within the multipath access system. The test vessels can be washed in one or more wash stations associated with the multipath access system. The one or more wash stations are capable of adding water (or other wash fluid) to the test vessels and rotating the test vessel on its vertical axes to eliminate the liquid while maintaining the solid phase material within the test vessel. The multipath access system can preferably also transfer test vessels back and forth between one or more continuous loop conveyors belts, or may transfer the test vessels to a sub assembly such as a luminometer. All of these capabilities may be carried out in a non-serial manner. Thus, each vessel (or a group of vessels) in the analyzer at a given time may travel an individual path that is tailored to perform the reactions/manipulations that are required for a specific assay, without interfering with (e.g. slowing down) the reactions/manipulations that are required to be carried out for other samples undergoing a different assay.

In a preferred embodiment, the multipath access system is associated with an incubator, and is preferably located within the associated incubator, forming a “multipath incubator”. However, the multipath access system may also be located in proximity to an incubator. For example, the multipath access system may be located adjacent to (e.g. beside, on top of, or under) an incubator so that test samples are delivered from the multipath access system to the incubator, from the incubator to the multipath access system, or both. Alternatively, the incubator may be located within the continuous loop formed by transport device of the multipath access system. Further, more than one multipath access system may be associated with an incubator.

Thus, in a preferred embodiment, the present invention provides a multipath incubator for use in an automated immunoassay analyzer. The multipath incubator includes a) a transport device (e.g. an incubator belt) having a plurality of vessel holding members where the transport device moves the plurality of vessels along one or more continuous loops; b) at least one delivery station for adding a vessel to the transport device at a specified vessel holding member of the plurality of vessel holding members; c) at least one transfer station for removing a vessel from the transport device or for replacing a vessel back onto the transport device (such as, for example, retrieval from a wash station); and d) a controller for controlling the transport of a vessel by the transport device from the vessel adding station to the vessel removing station based on information that (i) identifies a test or operation being performed in the vessel, and (ii) identifies a location of a vessel holder which holds the vessel within the transport device. The multipath incubator may further include at least one associated pipetting station for adding one or more reagents to a vessel positioned in a vessel holding member of the transport device. The multipath incubator may further include at least one associated wash station for washing test vessels positioned in said at least one wash station. In one embodiment, the at least one wash station is combined with the at least one transfer station.

The transport device is preferably movable in both forward and reverse directions. Further, each holding member of the plurality of vessel holding members may be locatable at a plurality of spaces equal in number to the plurality of vessel holding members, and the transport device will preferably move a preset number of spaces that is greater than one with every move. The preset number may include a sum of the number of spaces moved in a forward direction and a number of spaces moved in a reverse direction in a single move. The preset number may be an integer divisor of a total number of the plurality of vessel holding members in the transport device or between vessels on adjacent belts of the transport device.

The multipath incubator may further include at least one agitating member positioned adjacent to the transport device at a location where vessels in the plurality of vessel holding members contact the agitating member when the transport device is moved. The at least one agitating member is preferably stationary. The transport device may further include at least two continuous loops and may include a transfer station which transfers vessels between the at least two continuous loops.

The at least one transfer station may include a transfer device which moves a vessel from the transport device to at least one position spaced away from vessel holding members of the transport device. The at least one position spaced away from vessel holding members of the transport device may be located within a wash station for performing one or more wash operations on the vessel. The at least one position spaced away from vessel holding members of said transport device may be located within a luminometer. The transfer device may move a vessel from the transport device to at least two different positions spaced away from vessel holding members of the transport device. The multipath incubator may have at least two transfer stations.

The multipath access system of the present invention preferably includes a transfer station with a slide member which slides perpendicular to a portion of a path traveled by the transport device. The slide member may include at least two projection members projecting from the slide member which are spaced far enough apart to accommodate at least one test vessel there between, with at least one of the projection members contacting the vessel during movement of the slide member. In one embodiment, the slide member can move at least two vessels simultaneously where a first of the two vessels is removed from the transport device and moved to a station one position away from the transport device, and a second of the two vessels is moved to a station two positions away from the transport device. In one embodiment, the station one position away from the transport device is a wash station. In another embodiment, the station two positions away from the transport device is a luminometer subsystem. A transfer station with a slide member may also be used to transfer a test vessel between adjacent belts of the transport device.

The present invention provides a method for controllably moving vessels in an automated immunoassay analyzer according to varying time schedules. The method comprises the steps of 1) adding a plurality of vessels to a transport device having a plurality of vessel holding members; 2) identifying a test or operation to be performed in each of the plurality of vessels, and a location of a vessel holder which holds each of the vessels within the transport device; 3) transporting the plurality of vessels with the transport device along one or more continuous loops; 4) removing a vessel from or replacing a vessel onto the transport device; and 5) controlling the transporting and removing steps based on the test or operation to be performed and the location of the vessel holder identified in the identifying step. The transporting step may move in forward and reverse directions, and the number of spaces moved in the transporting step may be the same for every movement of the transporting device.

In one embodiment, the removing or replacing step is achieved using a transfer station which includes a transfer slide that moves perpendicular to a portion of a path traveled by the transport device, the transfer slide having one or more projecting members which contact a vessel and move the vessel while the transfer slide is moved. The method may further comprise the step of agitating the plurality of vessels during the transporting step.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is an overview of an automated immunoassay analyzer.

FIG. 2 is a block diagram of a single loop multipath incubator.

FIG. 3A-D shows a cross-sectional side view of a dedicated wash station for the multipath incubator.

FIG. 4A-D shows a cross-sectional side view of a combined wash and transfer station.

FIG. 5 is a table showing an example of the types of assays that may be requested for 5 separate samples, each of which is assayed in a separate test vessel or tube.

FIGS. 6A and B. A, shows an example of the movement of a test vessel in one direction along an incubator belt; B, shows an example of movement of a test vessel in two directions along an incubator belt.

FIG. 7 is a block diagram showing an embodiment of a multipath incubator with two continuous loops.

FIG. 8 shows a block diagram of the multipath incubator with a plurality of continuous loop incubator belts.

FIG. 9 shows another embodiment of a continuous incubator belt.

FIG. 10 is a series of flow charts showing a schematic depiction of processes for carrying out assays according to the present invention.

### DETAILED DESCRIPTION OF A PREFERRED EMBODIMENT OF THE INVENTION

In one embodiment, the present invention provides a multipath incubator that allows immunoassay tests to be performed in a controlled multiple path manner rather than in a “first in, first out” (FIFO) serial process. In the multipath incubator of the present invention, a sample in a test vessel or a group of samples in a group of test vessels can follow an incubation pathway that is individually tailored to carry out the physical manipulations (e.g. dilution, mixing, emptying, etc.) and chemical reactions (e.g. by addition of chemical reactants) on an individual schedule for a particular assay. This is accomplished without interfering with (e.g. slowing down) the reactions and manipulations that other samples in the incubator are undergoing, for example, for an entirely different assay, or for the same assay but under different conditions. For example, using the multipath incubator of the present invention, it is possible to incubate and process at the same time and in the same analyzer, one group of 20 vessels with an assay procedure requiring: sample dilution, addition of reagent, 2 minutes of incubation, and reading of the assay result; and a second group of 12 vessels requiring: no sample dilution, addition of reagent, 5 minutes of incubation, emptying of test vessel and washing of the vessel, addition of second reagent, second incubation of 10 minutes, emptying of test vessel and washing of the vessel, and reading of the assay result. Further, it would be possible to simultaneously carry out a single type of assay with 50 test vessels, subsets of which are incubated for increased lengths of time in order, for example, to find the optimum incubation period (e.g., the first 10 vessels are incubated for 5 minutes, the second 10 are incubated for 10 minutes, and so on). These variations can be accomplished by preprogramming the desired pathways and, in contrast to conventional incubators, do not require the intervention of a technician when switching from one pathway to another, and do not require that the pathway for one group of assays be completed prior to beginning the incubation pathway for another group of assays. Further, the assays are carried out without regard to what order the requested assays were entered into the analyzer.

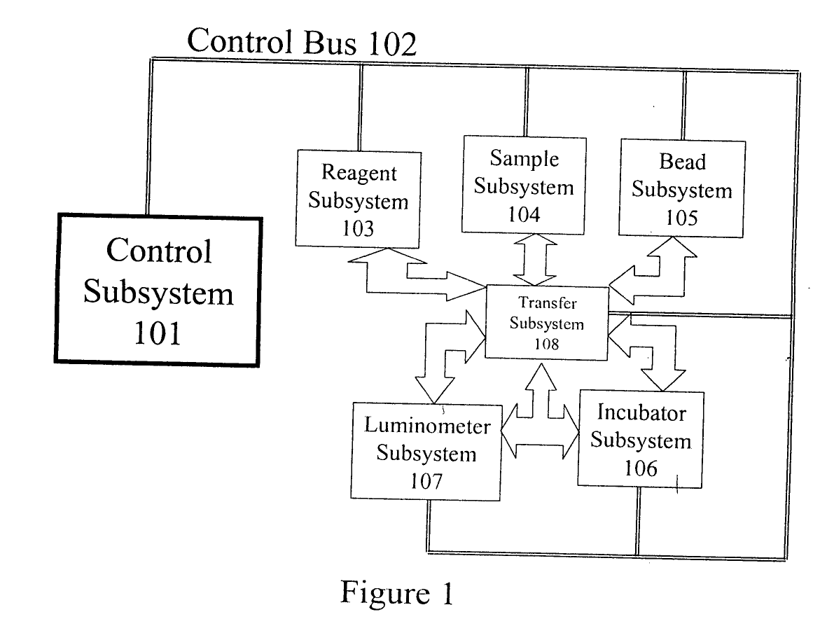

Referring now to the drawings, FIG. 1 shows an automated immunoassay analyzer as a complex system with numerous subsystems that allow tests to be performed without the continuous monitoring and intervention of a technician. The technician selects the tests to be performed for each sample and enters this information via the control subsystem 101. The control subsystem 101 manages the other subsystems by sending command and control information via the control bus 102. Samples of biological material (e.g., urine, plasma, etc.) are placed by the technician in the sample subsystem 104. The samples can be diluted within the sample subsystem 104 or can be tested in the undiluted state. The bead subsystem 105 adds the appropriate bead (e.g., a substrate with bound agent for binding an analyte of interest in the sample) to the test vessel and the reagent subsystem 103 adds the specified reagent to the test vessel. The selection of bead and reagent for each sample is managed by the control subsystem 101 based on the type of test to be performed on each sample. These subsystems include identification capabilities such as bar code readers or RF tag readers that read the identification information on the reagent containers, bead containers and sample tubes to ensure that correct components are added to each test vessel for testing. The test vessel is moved within the analyzer via the transfer subsystem 108. Once the selected components are added to the test vessel, the incubator subsystem 106 incubates and agitates the test vessel as managed by the control subsystem 101. The test vessel is then washed and transferred to the luminometer subsystem 107 via the transfer subsystem 108. The luminometer subsystem 107 selects the test vessel and presents it to a detection mechanism. After the read operation is performed, the test vessel is discarded.

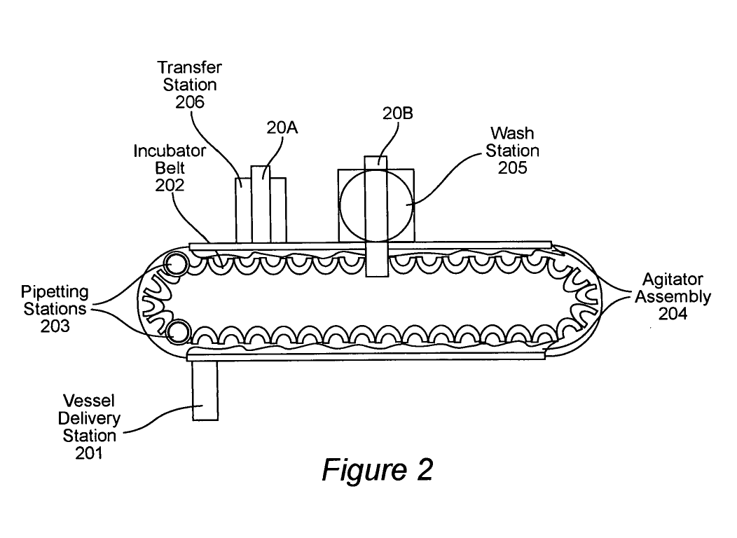

The present invention is directed to a multipath incubator system for use in such an automated analyzer. FIG. 2 shows a single continuous loop incubator embodiment of such a multipath incubator. A test vessel is presented to the multipath incubator at the vessel delivery station 201. The test vessel may contain a solid phase reagent or may be empty. The test vessel is moved along a transporter device such as the incubator belt 202. On the incubator belt 202, the test vessel is positioned so that it is centered over the belt in order to eliminate variation of speed as the vessel travels around corners. The test vessel is moved to a pipetting station 203 where liquid is added. The liquid that is added may include biological sample (e.g., blood, plasma, urine, etc.), or diluted biological sample, or liquid reagent. The type and quantity of the added liquid is dependent upon the type of assay being performed. The test vessel is moved around the incubator belt 202 for a period of time specified for the individual assay. As the test vessel is moved along the incubator belt 202, the test vessel is agitated by one or more agitator assemblies 204. The agitator assembly 204 is described in more detail in the co-pending application Babson et al. Ser. No 10/______, “Vessel Agitator Assembly. The multipath incubator is preferably contained within a housing (not shown) that is maintained at 37° C.±0.1° C. The test vessel progresses around the incubator belt 202 until it is scheduled to enter a wash station 205 or a transfer station 206.

Preferably, there is at least one wash station 205 associated with the incubator belt 202. In addition, one or more transfer stations may be associated with the incubator belt 202, depending on the overall incubator design. The purpose of a dedicated wash station is to remove the reaction liquid supernatant while retaining the solid phase reaction components, add a wash liquid (e.g. water), remove the wash liquid, etc., thus repeatedly washing the solid phase, and then to return the test vessel to the incubator belt from which it was removed. The purpose of a dedicated transfer station is to move a test vessel from an incubator belt to another location, such as to another incubator belt (in a system with two or more belts) or to a luminometer. In some embodiments of the invention, a wash and transfer station are combined, i.e. a test vessel it transferred into the wash station and the solid phase component of the reaction is washed, and then the test vessel is moved (transferred) out of the wash station to a location other than the incubator belt from which it was removed, e.g. to a different incubator belt or to a luminometer subsystem. The test vessel has thus been washed and transferred at a single combined station.

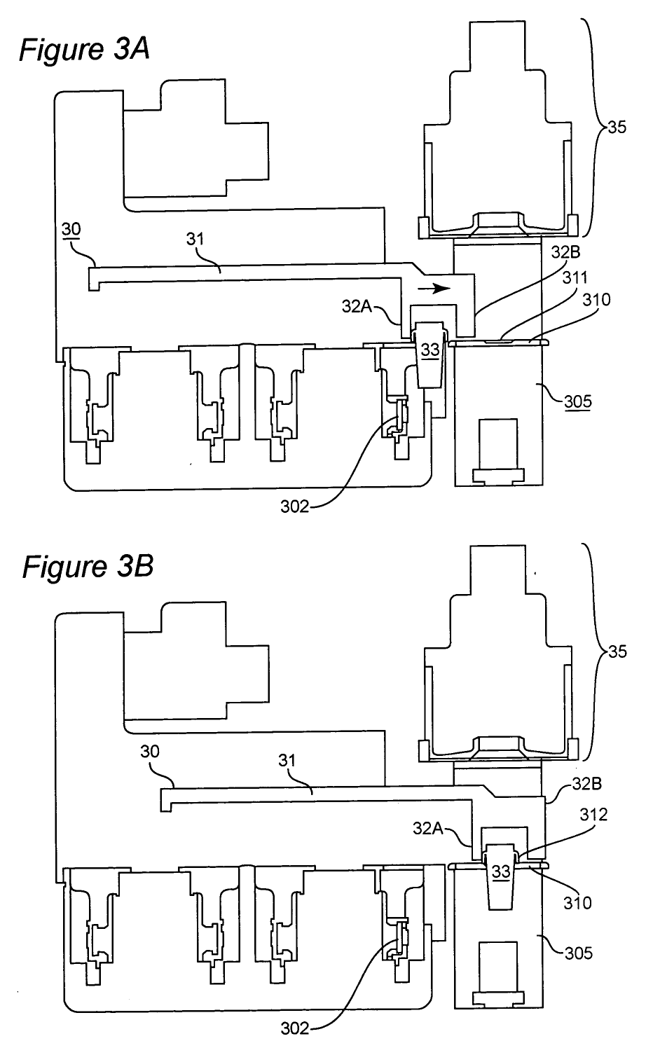

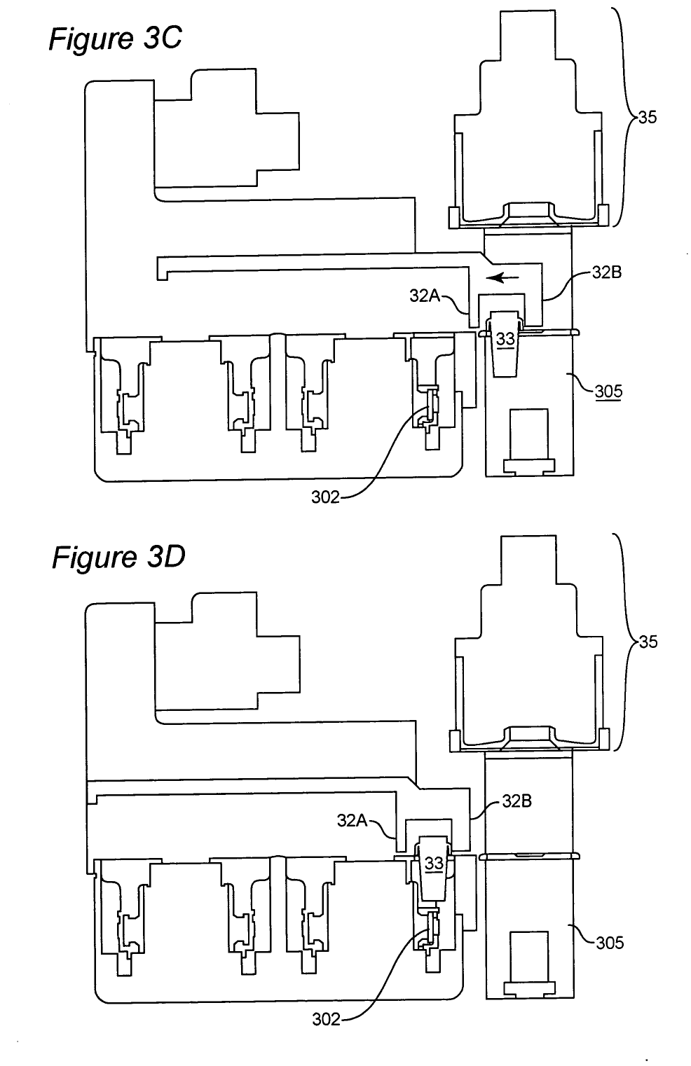

In wash stations, transfer stations, and combined stations, movement of the test vessel into and out of the station is preferably accomplished by means of a transfer slide, depicted schematically as 20A and 20B in FIG. 2. Referring to FIG. 3A-D for details, FIG. 3A depicts a dedicated wash station 305 with wash module 35. Transfer slide (shuttle) 30 comprises a horizontal support 31 with two members 32A and 32B projecting from horizontal support 31. The two projecting members 32 A and 32B are sufficiently spaced apart so as to accommodate a test vessel 33 between the two members. The members 32A and 32B are of sufficient size and rigidity that, when a test vessel 33 is located between the two members and the horizontal support 31 is moved, the test vessel is also moved by being pushed by one or the other of the members (whichever member contacts and is thus “behind” the test vessel with respect to the forward direction of movement of the vessel, e.g., member 32A in FIG. 3A). The test vessel is thus shuttled from the incubator belt 302 into support shelf (platform) 310 of the wash station 305, as shown in FIG. 3B. Support shelf 310 is open at one or both ends to allow entry and egress of the test vessel 33. In the wash station 305, the test vessel 33 is positioned with its flange 312 within depression 311 of support shelf 310. Support shelf 310 thus supports the test vessel 33 by its flange 312, which surrounds the test vessel. Depression 311 surrounds an opening in support shelf 310 (not shown) in which the test vessel is positioned.

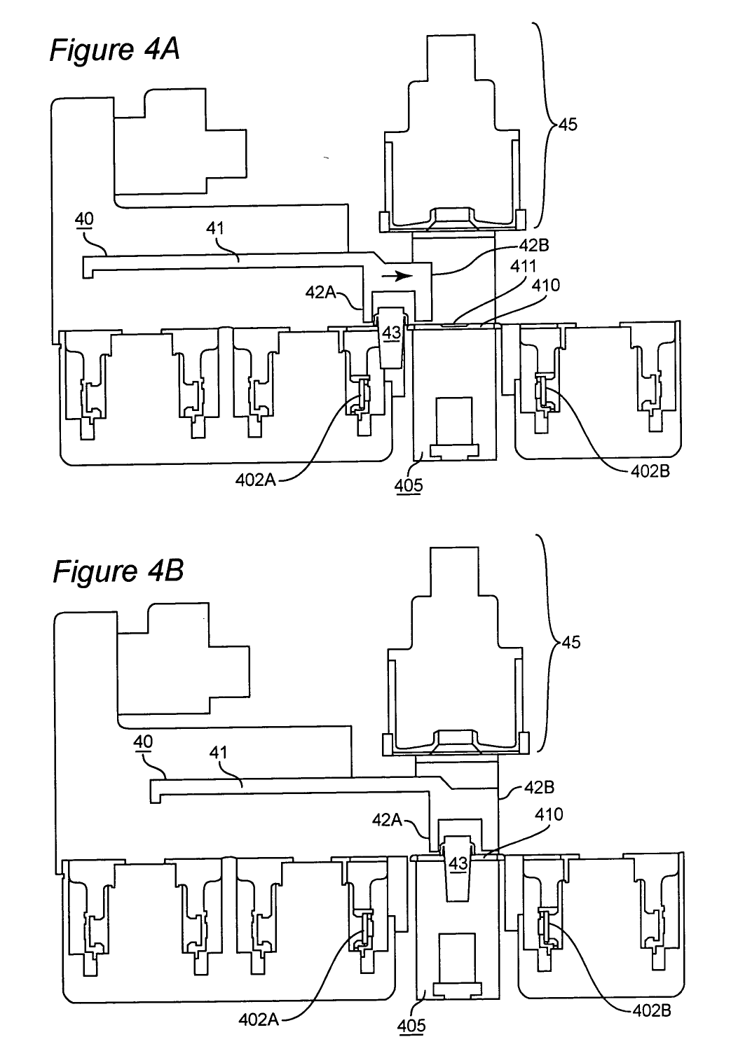

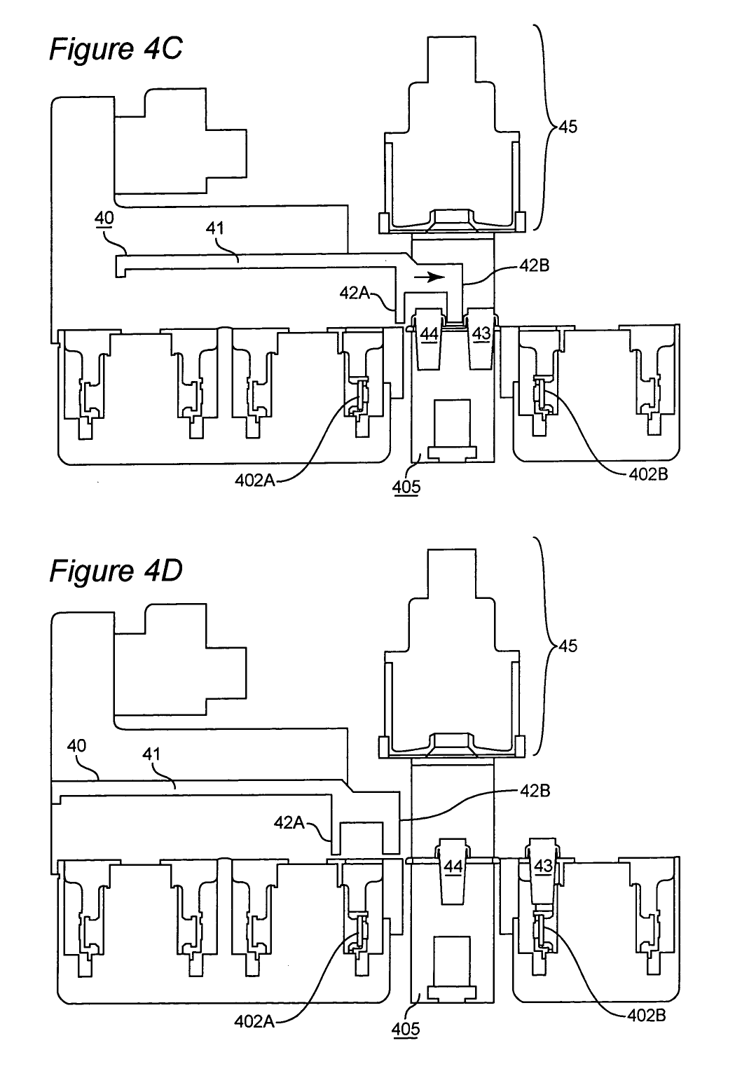

The test vessel is washed as described below, and after washing is removed from the wash station 305 by transfer slide 30 as shown in FIG. 3C, where projection 32B pushes the test vessel from the wash station 305 back onto the incubator belt 302 (FIG. 3D). Thus, when a single test vessel is moved into and out of a wash station as described above, the test vessel may simply ride between the projecting members of the slide. Alternatively, a single vessel may ride between the projecting members of the slide through a transfer station (or through a combined wash and transfer station) from one incubator belt to another. This embodiment is discussed in detail below and is illustrated in FIG. 4A-D.

Test vessels are washed via axial centrifugation. As illustrated in FIGS. 3A and B, the test vessel 33 is shuttled into the wash station 305 and positioned in support shelf 310. After the test vessel 33 is positioned in the support shelf 310 (as in FIG. 3B), support shelf 310 is lowered, thereby moving test vessel 33 down and allowing retraction of the shuttle 30. After retraction of shuttle 30, support shelf 310 is raised to its previous position (as in FIG. 3B). Wash module (sump housing) 35 preferably comprises an angled, splined gear, surrounded by a sump receptacle and a test vessel lifter (not shown). The test vessel lifter is raised to engage the bottom of the test vessel 33, which is raised out of the support shelf 310 and into the wash module 35. Test vessel 33 is then engaged by a bevel gear (not shown) and spun at high speed several times, with five times being preferred. The first spin removes the sample and reagent mixture. Water and/or wash fluid is dispensed into the test vessel prior to the follow-on (e.g., second, third, fourth, and fifth, etc.) spins. Washing and spinning is repeated several times (e.g. 5 or more times) until the tube and solid phase (bead) is free of non-specifically bound label. Expelled fluids are captured in the sump and drained away (drain tube not shown). After sufficient washing, the tube is lowered to again engage the support shelf 310 which is then lowered to allow the shuttle 30 to be repositioned over the tube 33. Support shelf 310 is then raised to the initial position to allow the shuttle 30 to retract test vessel 33 back onto the incubator belt 302. Alternatively, with reference to FIG. 4, the test vessel may be shuttled onto a second incubator belt 402B if the second incubator belt is to transport the test vessel to the next step of processing. In yet another embodiment, if the assay is complete and the next step is to read the result, the test vessel may be shuttled to a luminometer. The luminometer and its operation are described in more detail in the co-pending application, “Rotary Luminometer,” Ser. No. 10/______.

The transfer slide (shuttle) is also able to accommodate two test vessels in a single movement. FIG. 4A-D depicts a test vessel 43 entering a combined wash and transfer station 405. In FIG. 4A, transfer slide 40 comprises a horizontal support 41 with two members 42A and 42B projecting from horizontal support 41. The test vessel 43 is pushed from incubator belt 402A by projecting member 42A and positioned in the support platform 410 of station 405 as shown in FIG. 4B. The wash occurs in wash module 45 as described above. However, in this embodiment, the transfer slide 40 moves back to capture a second test vessel 44 from the incubator belt 402A (FIG. 4C), and concomitant with moving the second test vessel 44 into position in the wash station via projecting member 42A, moves the washed test vessel 43 out of the wash station 405 via projecting member 42B to a position on the opposite side of the wash station, e.g., to another incubator belt 402B (FIG. 4D), or to a luminometer subsystem (not shown). Thus, in a single movement of the transfer slide, two test vessels are repositioned. Transfer slide 40 then returns to capture yet another test vessel (not shown) from incubator belt 402A.

With reference to FIG. 2, The transfer station 206 can be a separate element as shown in FIG. 2, i.e., it need not be associated with a wash station. In this case, the transfer slide 20A removes a test vessel from the incubator belt 202 as described above for a wash station, and transfers the test vessel to another location away from the incubator belt 202, e.g. to a luminometer, or to another incubator belt in a multi-belt system.

This description of a single test vessel progressing through the multipath incubator does not fully explore the advantages of the multipath capability. This capability is more obvious when numerous test vessels are presented to the multipath incubator and a variety of assays are to be performed.

As discussed above, the immunoassay analyzer performs numerous tests (assays) on a variety of samples. Each assay has unique requirements to include but not be limited to: types of reagents added, duration of incubation, numbers of reagents added, dilution, agitation, and number of wash cycles. This invention allows assays to be performed in accordance with their own resource requirements without regard to what order the requested assays were entered into the analyzer.

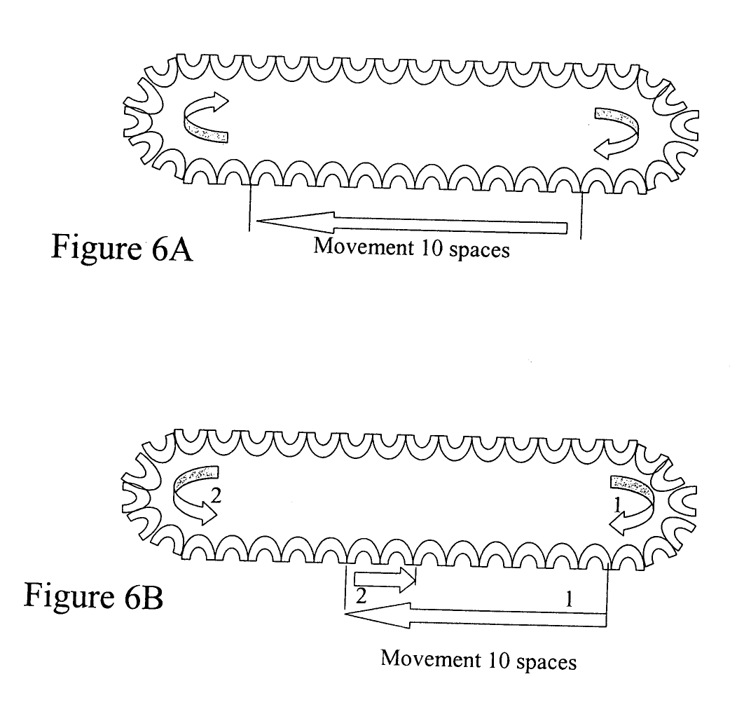

FIG. 6 is a table showing an example of the types of assays that may be requested for 5 separate samples, each of which is assayed in a separate test vessel or tube. This table is only used for descriptive purpose and should not be construed as limiting the multipath incubator to only these features, functions, attributes, or tests.

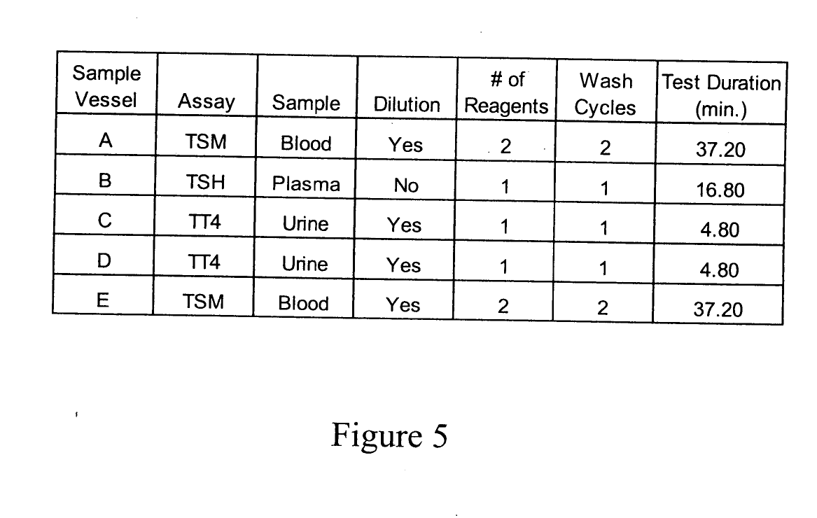

Referring again to FIG. 2 (using the data provided in FIG. 5) for the purposes of this discussion, the test vessels (A-E) will be delivered to the multipath incubator at vessel delivery station 201. Each test vessel (A-E) will contain the appropriate solid phase reagent for each specified assay. Test vessel A arrives on the incubator belt 202 and is moved to a pipetting station 203. Diluted biological sample (e.g., blood serum, urine, etc.) is dispensed into test vessel A. While test vessel A is receiving the pipetted sample, test vessel B arrives on the incubator belt 202 and is moved to the pipetting station 203 to receive the plasma for tests. While test vessel B is receiving the plasma sample, test vessel A has moved to another pipetting station where it is receiving the first reagent. Likewise, test vessels C, D, and E arrive at the incubator belt 202 and are moved around to receive the appropriate samples and reagents at the pipetting stations 203. As the test vessels are moved along the incubator belt 202, they are agitatated by bumping the agitator assembly 204. Movement along the incubator belt 202 may be in either the clockwise or counterclockwise direction. Test vessel A may have entered the incubator belt 202 at vessel delivery station 201 and moved one space in the clockwise direction to the pipetting station 203 to receive a sample for test. Test vessel B could enter the incubator belt 202 at the vessel delivery station 201 and move in the counterclockwise direction to a pipetting station to receive a sample for test. As each of the test vessels (A-E) receive the sample fluids and the reagents, they are moved along the belt according to the assay requirements. Test vessels C and D require a short amount of incubation time relative to test vessels A and E. Although test vessels C and D may have entered the incubator belt 202 after test vessel A, test vessel C could be moved into the wash station before test vessels A and B. Test vessel C would be washed in wash station 205 and transferred to the luminometer by transfer station 206. Likewise, test vessel D would enter the wash station 205 and then move into the luminometer via transfer station 206.

Although the direction traveled around the continuous loop of the incubator belt 202 may be different, each test vessel of a particular assay preferably travels the same distance. For example, with reference to FIGS. 6A and B, a test vessel can move a distance of ten spaces in one direction as shown in FIG. 6A. However, moving the test vessel eight spaces in one direction and two spaces back in the other direction as shown in FIG. 6B is also traveling 10 spaces. Hence, for each type of assay performed, the test vessel must travel the same distance as all other test vessels undergoing the same assay. This is to ensure that each assay has a consistent incubation duration and a consistent agitation duration.

Referring again to FIG. 2 (using the data provided in FIG. 5) test vessel A would enter the wash station 205 and then be moved back onto the incubator belt 202. Test vessel A would be moved to a pipetting station 203 where it would receive the second addition of a reagent. In the mean time, test vessel B has entered the wash station 205 and has been transferred to the luminometer via transfer station 206. Test vessel E has moved onto the incubator belt 202, has received its sample and reagent at the various pipetting stations and has moved around the incubator belt 202 in a similar fashion to test vessel A. That is, since test vessel A and test vessel E are conducting the same test, each test vessel (A and E) must move the same number of spaces and must remain in the incubator for the same duration of time. Test vessel A then enters the wash station 205 for the second time and is then moved to the luminometer via the transfer station 206. Test vessel E is washed for the first time, returns to the incubator belt 202 and receives the second reagent at the pipetting station 203. Finally, test vessel E is moved back to the wash station 205 and then into the luminometer by transfer station 206. Thus, although the test vessels entered the analyzer in the order A, B, C, D, and E, the tests were completed in the order C, D, B, A, and E.

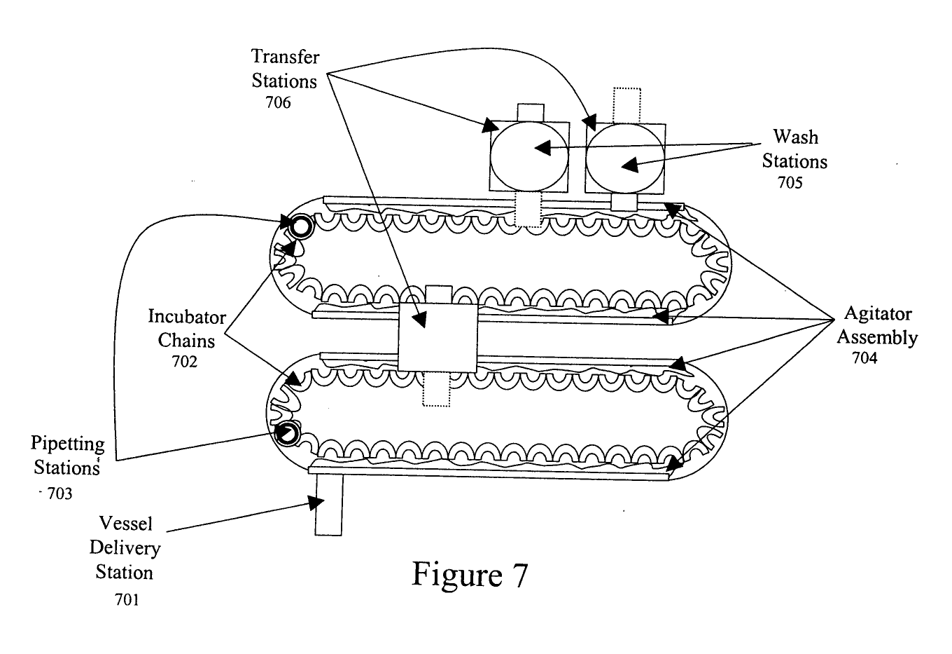

Referring now to FIG. 7, another embodiment of the multipath incubator is shown. This embodiment shows two continuous loops of the incubator belts 702. It also shows the similar vessel delivery station 701 and pipetting stations 703 as for the single continuous loop embodiment.

Only one pipetting station 703 is shown on each of the two incubator belts 702, however, this is not meant to limit the invention to only having one pipetting station per incubator belt 702. This embodiment also shows a transfer station 706. This transfer station 706 is to move test vessels between incubator belts 702. Finally, this embodiment also includes the agitator assemblies 704. One or more agitator assemblies 704 may be provided per incubator belt 702.

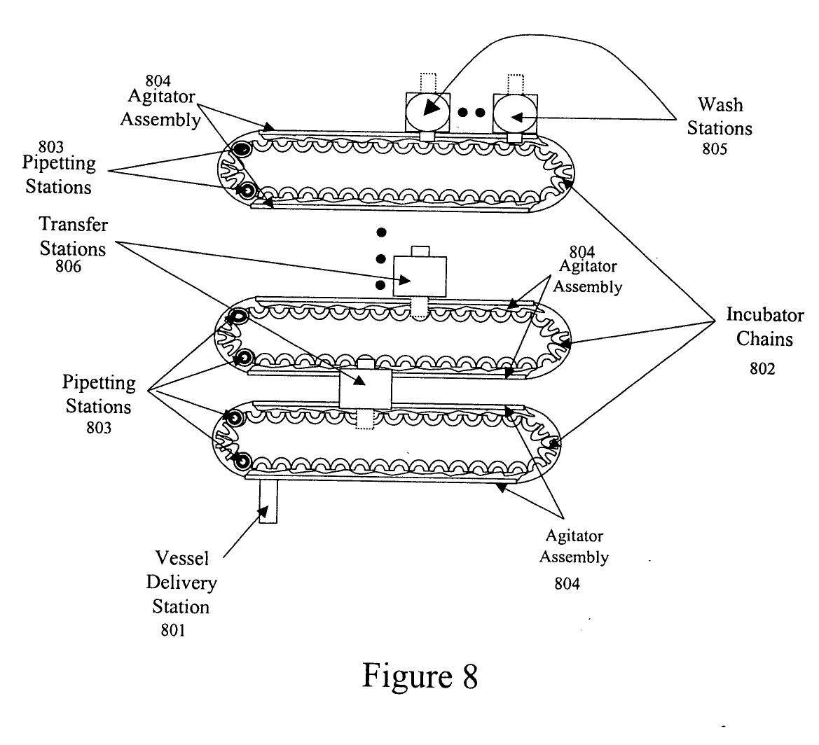

Another embodiment shown in FIG. 8 would be to provide more than two of incubator belts 802. As the number of continuous loops increases, the number of vessels able to undergo testing in the analyzer increases, as do the number of transfer stations 806, wash stations 805, pipetting stations 803, and agitator assemblies 804.

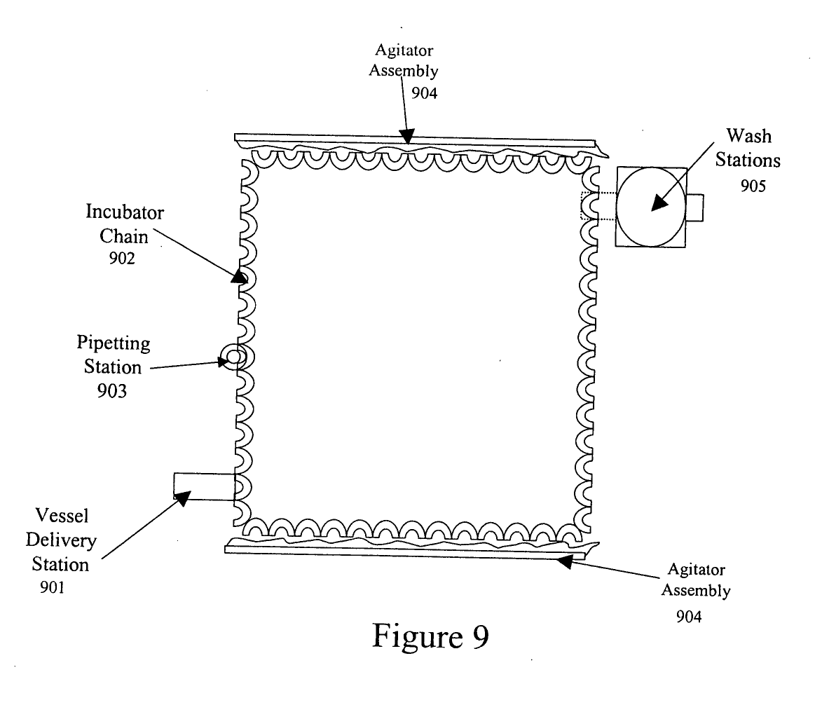

Regarding the various embodiments of incubator belt arrangements, those of skill in the art will recognize that many such arrangements involving combinations of various numbers and shapes of incubator belts are possible, including but not limited to e.g. various polygons such as squares, triangles, rigid carousels, etc. Further, the number and location of pipetting, wash, and transfer, and vessel delivery stations may be varied in order to accommodate the needs or goals of a given analyzer instrument. All such combinations are intended to be encompassed by the present invention, so long as the resulting combination provides the features and advantages of the multipath incubator as described herein. One such embodiment is shown in FIG. 9 as a single continuous loop with a shape other than an oval. Rather, the single continuous loop of the incubator belt 902 is a square, with vessel delivery station 901, pipetting stations 903, agitator assembly 904, and wash station 905.

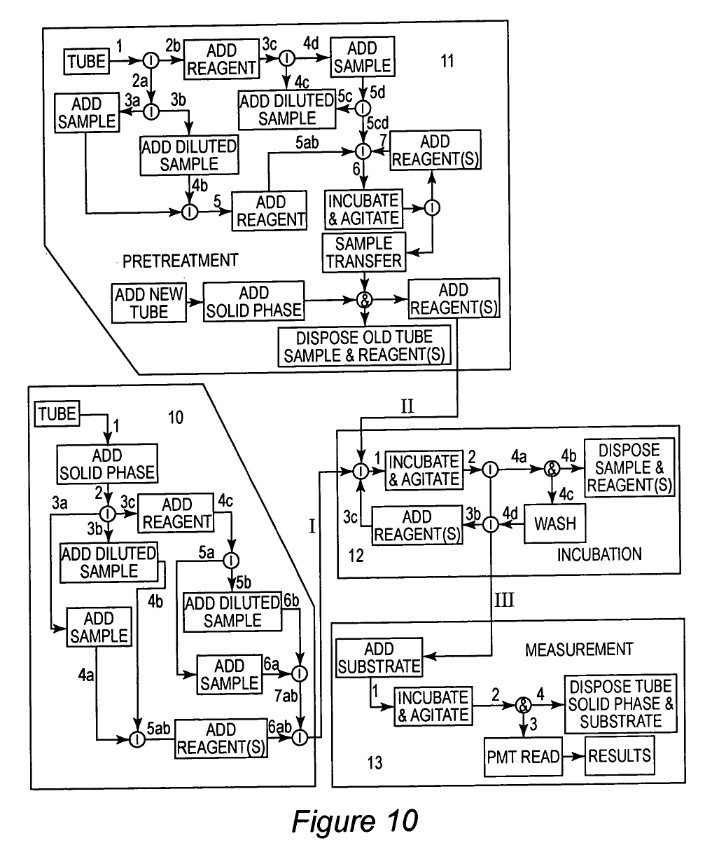

The multipath incubator of the present invention preferably operates in a manner that is depicted schematically as a series of flow charts in FIG. 10, where the flow chart in pentagon 10 represents a standard assay procedure, the flow chart in pentagon 11 represents a pretreatment assay process, the flow chart in rectangle 12 represents an incubation process, and rectangle 13 represents a measurement process. The processes are linked to one another and are carried out by software programs that allow a choice of the identity, order and timing of the steps of an assay. A resource allocation algorithm (as described in co-pending U.S. patent application Ser. No. 10/______) is preferably utilized in order to maximize throughput on the instrument. The various sub-schemes can be conveniently understood by considering them one by one. In each schematic process, the steps of the process are given inside the small rectangles located within the flow chart. The pathways for moving from one step to another are represented by arrows, and will typically coincide with physical movement of a sample tube from one section of the instrument to another (e.g. from a pipetting station to a transfer or wash station) by means of a transport device such as an incubator belt. In each of the schematic processes, a “circle containing a vertical line” represents an “or” junction. An “or” junction is a nexus in the process which may be arrived at or exited from by more than one input or output (I/O) path, i.e., it is a point of connection in the process where a choice must be made between various options, or where a choice between various options was made in order to arrive at the junction. This is in contrast to the junctions marked with a “circle with a &”, i.e., the “and” junctions. For “and” junctions, all of the possible input and output paths (represented by arrows) to and from that junction must occur. Terminal process steps are indicated by shading of the corresponding rectangle.

A. Standard Assay Process: Pentagon 10

The sub-scheme shown in Pentagon 10 represents a standard assay process. In the sub-scheme, an assay tube that is entering the assay process is represented by the shaded rectangle in the upper left corner of the pentagon 10 that is labeled “tube”. This represents the beginning of the standard assay process illustrated in Pentagon 10. The arrow 1 leaving the tube leads to the first step of the process, which is “add solid phase”. In other words, in this standard assay process, the first step is to add to the assay tube a solid phase that is relevant to the assay that is being carried out. In preferred embodiments, such a solid phase might be, for example, a bead to which an antibody molecule is attached. (A more detailed discussion of solid phases is given below.) Following this step, the arrow 2 leads to an “or” junction from which any one of three different pathways (3a, 3b or 3c) may be pursued. If pathway 3a is selected, the next step in the assay is to “add sample”. If pathway 3b is selected, the next step is to “add diluted sample”. Lastly, if pathway 3c is selected, the next step is to “add reagent” to the tube. Examples of suitable samples and reagents for utilization in the practice of the present invention are discussed below.

Those of skill in the art will recognize that this first tier of choices (arrows 3a, 3b and 3c) is designed to accommodate a variety of common assay strategies: the use of undiluted sample directly to a solid phase reagent, the dilution of the sample prior to addition to the solid phase, and the addition of one of more additional reagents to the solid phase prior to sample addition, all of which can be accomplished in a single analytical instrument using the multipath incubator of the present invention.

Pathways 3a and 3b then proceed via arrows 4a and 4b, respectively, to a second “or” junction. (This is an “or” junction because two possible pathways lead to it, either of which may have been followed). For both 4a and 4b, there is a single pathway leading from the “or” junction, pathway 5ab, which leads to the step of the addition of one or more reagents to the assay tube. This is reasonable because both assay tubes from both the 4a and 4b pathways already contain all other requisite assay components: 1) sample, either diluted or not; and 2) solid phase reagent. Then, having added the one or more reagents, assay tubes from the 5ab pathway follow arrow 6ab to the last “or” junction of the standard assay procedure and are ready to begin the next phase of the assay (incubation) by following the arrow marked as “I”.

Pathway 3c is essentially the reciprocal of 3a and 3b. Having first added one or more reagents, the sample (either diluted or not) is afterwards added to the assay tube. This is accomplished by following arrow 4c to the junction at which the choice is made between adding sample without dilution (arrow 5a) or adding diluted sample (arrow 5b). The addition of sample to the assay tubes is the last step prior to following arrows 6a and 6b to the final “or” junction. The 3c pathway assay tubes now contain all necessary assay components, and are ready to move via arrow 7ab to the last “or” junction, which they share with the 3a and 3b pathway samples. They can then proceed to the incubation phase of the assay via arrow I.

As can be seen, tubes that arrive at the final “or” junction in sub-scheme 10 just prior to incubation may have followed any of four different pathways: 1) addition of undiluted sample followed by reagent addition; 2) addition of diluted sample followed by reagent addition; 3) addition of reagent followed by addition of undiluted sample; and 4) addition of reagent followed by addition of diluted sample. In a conventional analyzer, such variation in assay pathways would require lengthy serial incubations and/or frequent intervention by the technical operator. By utilizing the multipath incubator of the present invention, such multiple assay pathways with differing requirements may be pursued at the same time in the same instrument after a single initiation procedure/start time, or after multiple start times, at the convenience of the operator.

B. Pretreatment: Pentagon 11

Pentagon 11 represents a sub-scheme into which pretreatment of a sample has been programmed. Referring to pentagon 11, multiple pathways can also be traced through the flow chart presented therein. In this case, the sample is pretreated prior to being added to the solid phase and reagents that are needed for the ultimate assay. An example of the need for pretreatment is an assay for vitamin B 12 in which the analyte must be released from endogenous binding proteins in serum with a reducing agent prior to reactions involving the solid phase. Beginning with the assay tube depicted in the upper left hand corner, as is the case for the assay in pentagon 10, there are four pathways that may be followed: 1) the addition of sample followed by addition of reagent (arrows 2a, 3a, 4a, and 5); 2) the addition of diluted sample followed by addition of reagent (arrows 2a, 3b, 4b, and 5); 3) the addition of reagent followed by the addition of sample (arrows 2b, 3c, 4d, 5d, 5cd, and 7); and 4) the addition of reagent followed by the addition of diluted sample (arrows 2b, 3c, 4c, 5c, 5cd, and 7). All four paths converge at an “incubate and agitate” step, (immediately following arrow 6) which is then followed by an “or” junction. At the “or junction, either additional reagents may be added (followed by reincubation and agitation and return to the same “or” junction), or the sample may be transferred to the next stage of the process (“sample transfer”). If sample transfer occurs, the assay proceedings arrive at an “and” junction where the contents of the assay tube are transferred to a new tube (which already contains a suitable solid phase reagents for carrying out the assay for the product), and the old tube is disposed of. The assay tube and contents are then ready to be transferred to the incubation phase of the assay via arrow II.

Again, by utilizing an assay instrument with a multipath incubator as described in the present invention, assays requiring such different steps may carried out simultaneously. Further, multiple assays as described in the sub-schemes depicted in Pentagons 10 and 11 may be carried out simultaneously in the same analyzer.

C. Incubation Phase: Rectangle 12

Upon entry into the incubation phase of the assay system, all assay tubes from all pathways pass through a first “or” junction to a step of incubation and agitation via arrow 1. Those of skill in the art will recognize that the time of incubation may vary widely from assay to assay. Depending on the particulars of an assay, the time of incubation may be in the range of a few minutes to several hours. An advantage of the present invention is that by using the multipath incubator of the present invention, assays with differing incubation time requirements may be carried out simultaneously in the same assay instrument.

Upon completion of incubation and agitation, the assays proceed to an “or” junction by following arrow 2. At this “or” junction, a choice is made between 1) the addition of additional reagents to the assay (via arrows 3a and 3b; or 2) the step of sample and reagent disposal, and washing of the solid phase via arrows 4a, 4b and 4c. If the latter path is chosen, after a washing step and arrival at an “or” junction via arrow 4d, it is possible either to add additional reagents and re-incubate (arrows 3b and 3c), or to exit the incubation phase and enter the measurement phase by following arrow III. If the former path is chosen, eventually, after sufficient steps of adding reagents, incubating and washing, the assay will be complete and ready to enter the measurement phase via arrow III.

D. Measurement Phase: Rectangle 13

In the measurement phase of the assay, the amount of analyte of interest is quantified. As illustrated in rectangle 13, a suitable substrate and/or chemical reagent is added to the assay tube, the tube (via arrow 1) is incubated with agitation for an appropriate amount of time, and (via arrows 2 and 3) the resulting signal is read using a photomultiplier tube (PMT) whilst tube disposal is carried out via arrow 4. In preferred embodiments, chemiluminescent techniques are used to quantify the analyte.

Those of skill in the art will recognize that many types of assays are amenable to being carried out advantageously by utilizing the multipath incubator of the present invention. In preferred embodiments, the assays are immunoassays. Some general test categories include but are not limited to those directed to thyroid function, hormones, tumor markers, infectious diseases, allergy testing, detection of proteins and/or peptides and fragments thereof [e.g., immunoglobulin and related proteins and peptides, or prostrate specific antigen (PSA)], steroids; drugs and other small molecules (e.g. therapeutic drugs and/or drugs of abuse); vitamins; various biochemical metabolites; nucleic acids; polysaccharides; cellular fragments; etc.

In order to carry out such assays, a wide variety of solid phases may be employed. Examples include but are not limited to solid phases such as beads, magnetic particles, etc. In a preferred embodiment, the solid phase is a bead.

Those of skill in the art will recognize that the field of immunological detection is well-developed and that a plethora of suitable substrates and detection strategies are known that may be utilized in the measurement phase of an immunological assay, so long as exposure of the assay mixture to the substrate results in the production of a detectable, measurable signal.

Likewise, many types of samples exist which may be analyzed advantageously by practicing the methods of the present invention. Examples of samples that may be analyzed by the practice of the present invention include but are not limited to serum, plasma, urine, cerebrospinal fluid, amniotic fluid, saliva, tissue extracts, etc.

While the invention has been described in terms of a few preferred embodiments, those skilled in the art will recognize that the invention can be practiced with modification within the spirit and scope of the appended claims.

1. A multipath access system for use in an automated immunoassay analyzer, comprising:
a transport device having a plurality of vessel holding members, said transport device moving said plurality of vessels along one or more continuous loops;
at least one delivery station for adding a vessel to said transport device at a specified vessel holding member of said plurality of vessel holding members;
at least one transfer station for removing a vessel from and replacing a vessel onto said transport device; and
a controller for controlling the transport of a vessel by said transport device from said delivery station to said transfer station based on information
(i) identifying a test or operation being performed in said vessel, and
(ii) identifying a location of a vessel holder which holds said vessel within said transport device.

2. A multipath access system as recited in claim 1 further comprising at least one pipetting station for adding one or more reagents to a vessel positioned in a vessel holding member of said transport device.

3. A multipath access system as recited in claim 1 further comprising at least one wash station for washing test vessels positioned in said at least one wash station.

4. A multipath access system as recited in claim 3 wherein said at least one wash station is combined with said at least one transfer station.

5. A multipath access system as recited in claim 1 wherein said transport device is movable in both forward and reverse directions.

6. A multipath access system as recited in claim 1 wherein each holding member of said plurality of vessel holding members are locatable at a plurality of spaces equal in number to said plurality of vessel holding members, and wherein said transport device moves a preset number of spaces that is greater than one with every move.

7. A multipath access system as recited in claim 6 wherein said preset number includes a sum of the number of spaces moved in a forward direction and a number of spaces moved in a reverse direction in a single move.

8. A multipath access system as recited in claim 6 wherein said preset number is an integer divisor of a total number of said plurality of vessel holding members in said transport device.

9. A multipath access system as recited in claim 1 further comprising at least one agitating member positioned adjacent said transport device at a location where vessels in said plurality of vessel holding members contact said agitating member when said transport device is moved.

10. A multipath access system as recited in claim 9 wherein said at least one agitating member is stationary.

11. A multipath access system as recited in claim 1 wherein said transport device is comprised of at least two continuous loops and includes a transfer device which transfers vessels between said at least two continuous loops.

12. A multipath access system as recited in claim 1 wherein said at least one transfer station includes a transfer device which moves a vessel from said transport device to at least one position spaced away from vessel holding members of said transport device.

13. A multipath access system as recited in claim 12 wherein said at least one position spaced away from vessel holding members of said transport device is located within a wash station for performing one or more wash operations on said vessel.

14. A multipath access system as recited in claim 12 wherein said at least one position spaced away from vessel holding members of said transport device is located within a luminometer.

15. A multipath access system as recited in claim 12 wherein said transfer device moves a vessel from said transport device to at least two different positions spaced away from vessel holding members of said transport device.

16. A multipath access system as recited in claim 1 having at least two transfer stations.

17. The multipath access system of claim 1 wherein said transfer station includes a slide member which slides perpendicular to a portion of a path traveled by said transport device.

18. The multipath access system of claim 17 wherein said slide member includes at least two projection members projecting from said slide member which are spaced far enough apart to accommodate at least one test vessel therebetween, at least one of said projection members contacting said vessel during movement of said slide member.

19. The multipath access system of claim 18 wherein said slide member can move at least two vessels simultaneously where a first of said two vessels is removed from said transport device and moved to a station one position away from said transport device, and a second of said two vessels is moved to a station two positions away from said transport device.

20. The multipath access system of claim 19 wherein said station one position away from said transport device is a wash station.

21. The multipath access system of claim 19 wherein said station two positions away from said transport device is a luminometer subsystem.

22. A method for controllably moving vessels in an automated immunoassay analyzer according to varying time schedules, comprising the steps of:
adding a plurality of vessels to a transport device having a plurality of vessel holding members;
identifying a test or operation to be performed in each of said plurality of vessels, and a location of a vessel holder which holds each of said vessels within said transport device;
transporting said plurality of vessels with said transport device along one or more continuous loops;
removing a vessel from or replacing a vessel onto said transport device; and
controlling said transporting and removing steps based on the test or operation to be performed and the location of said vessel holder identified in said identifying step.

23. The method of claim 22 wherein said transporting step moves in forward and reverse directions.

24. The method of claim 23 wherein a number of spaces moved in said transporting step is the same for every movement of said transporting device.

25. The method of claim 22 wherein said removing or replacing step is achieved using a transfer station which includes a transfer slide that moves perpendicular to a portion of a path traveled by said transport device, said transfer slide having one or more projecting members which contact a vessel and move said vessel while the transfer slide is moved.

26. The method of claim 22 further comprising the step of agitating said plurality of vessels during said transporting step.
